(19) United States
(12) Patent Application Publication
(10) Pub. No.: US 2009/0281844 A1
(43) Pub. Date: Nov. 12, 2009

(54) Charter Transport Service Information Management System

(76) Inventor: Joseph M. Probst, Williamsville, NY (US)

Correspondence Address: WALTER W. DUFT;LAW OFFICES OF WALTER W. DUFT, 8616 MAIN ST, SUITE 2, WILLIAMSVILLE, NY, 14221, US

(21) Appl. No.: 12/436,617

(22) Filed: May 6, 2009

Related U.S. Application Data
(60) Provisional application No. 61/052,092, filed on May 9, 2008.

(51) Int. Cl. G06Q 50/00; G06F 3/048; G06Q 10/00; G06F 17/30; G06Q 30/00

(52) U.S. Cl. 705/5; 715/862; 705/400; 707/3; 705/27; 707/E17.014; 707/E17.018; 707/E17.044; 707/E17.019

(57) ABSTRACT

A machine-implemented technique for supporting interactions between charter transport service providers and service users. The technique utilizes an information management system to establish a real-time information exchange website that allows transport service users to request transport missions and transport service providers to view the mission requests in a pictorial format that assists the providers in offering mission quotations.

### CROSS-REFERENCE TO RELATED APPLICATIONS

This application claims the benefit of U.S. Provisional Patent Application Ser. No. 61/052,092, filed on May 9, 2008 (the '092 application). The contents of the '092 application are hereby incorporated by this reference in their entirety as if fully set forth herein.

### BACKGROUND

1. Field of the Invention

The present invention relates to the provision of charter transport service, including but not limited to air ambulance transport, cargo shipping, vehicle charter, aircraft charter, watercraft charter, and other activities involving non-scheduled transport.

2. Description of the Prior Art

By way of background, charter transport service involves the non-scheduled transport of persons or goods from one point to another. The term “non-scheduled” refers to the fact that the transport mission is not based on a fixed schedule such as a commercial air carrier, passenger railroad line, or metropolitan bus service might use. Currently, such missions are arranged on an ad hoc basis in which a user in need of transport service locates a transport provider, specifies mission requirements, and negotiates a satisfactory transport arrangement. This user/provider interaction model can be problematic, particularly for the provider who must typically assess the mission requirements of multiple users requesting different origins and destinations, assess transport resource availability, and formulate a pricing strategy that will allow service to be profitably rendered.

### SUMMARY

A machine-implemented technique is disclosed for supporting interactions between charter transport service providers and service users. The technique utilizes an information management system to establish a real-time information exchange website that allows transport service users to request transport missions and transport service providers to view the mission requests in a pictorial format that assists the providers in offering mission quotations.

According to example embodiments set forth herein, the information management system receives mission information from users specifying a mission origin, a mission destination and a mission time frame for the missions. The mission information is used to generate a web page for a map image that depicts a geographic region and a mission vector representation for one or more of the transport missions requested for a particular time frame whose mission origin and mission destination are within the geographic region. A map image output operation is performed that includes serving the web page for display of the map image to a provider. Filter data may be received from a provider that is used to generate the web page so that the map image contains information that is pertinent to the provider. The filter data may include the geographic region and the time frame, and may further include a provider asset location that is depicted in the map image to allow the provider to match the asset location with nearby missions. The web page may also be programmed to present specific information regarding a mission in response to selection of a vector corresponding to the mission using a computer cursor. The information management system may also support provider communication with users regarding mission delivery.

### BRIEF DESCRIPTION OF THE DRAWINGS

The foregoing and other features and advantages of the invention will be apparent from the following more particular description of example embodiments, as illustrated in the accompanying Drawings, in which:

FIG. 1 is a functional block diagram showing an information management system for supporting interactions between charter transport service providers and service users;

FIG. 2 is a functional block diagram showing example hardware components of an embodiment of the information management system of FIG. 1;

FIG. 3 is a flow block diagram showing example operations that may be performed using the information management system of FIG. 1;

FIG. 4 is an example home page interface that may be generated by an embodiment of the information management system of FIG. 1;

FIG. 5 is an example mission request interface that may be generated by an embodiment of the information management system of FIG. 1;

FIG. 6 is an example provider listing interface that may be generated by an embodiment of the information management system of FIG. 1;

FIG. 7 is an example map filter interface that may be generated by an embodiment of the information management system of FIG. 1;

FIG. 8 is an example map interface showing mission information for a first time frame that may be generated by an embodiment of the information management system of FIG. 1;

FIG. 9 is another example map interface showing mission information for a second time frame that may be generated by an embodiment of the information management system of FIG. 1;

FIG. 10 is another example map interface showing mission information for a third time frame that may be generated by an embodiment of the information management system of FIG. 1;

FIG. 11 is another example map interface showing mission information in relation to a transport asset location that may be generated by an embodiment of the information management system of FIG. 1;

FIG. 12 is another example map interface showing an example route optimization plan based on a sequence of missions and deadhead legs that may be generated by an embodiment of the information management system of FIG. 1;

FIG. 13 is another example map interface showing another example route optimization plan based on a sequence of missions and deadhead legs that may be generated by an embodiment of the information management system of FIG. 1;

FIG. 14 is another example map interface showing another example route optimization plan based on a sequence of missions and deadhead legs that may be generated by an embodiment of the information management system of FIG. 1;

FIG. 15 is another example map interface showing another example route optimization plan based on a sequence of missions and deadhead legs that may be generated by an embodiment of the information management system of FIG. 1;

FIG. 16 shows the example map interface of FIG. 15 with accompanying mission information text that may be generated by an embodiment of the information management system of FIG. 1;

FIG. 17 is an example quotation interface that may be generated by an embodiment of the information management system of FIG. 1;

FIG. 18 is an example quotation viewing interface that may be generated by an embodiment of the information management system of FIG. 1;

FIG. 19 is a quotation price matrix interface that may be generated by an embodiment of the information management system of FIG. 1;

FIG. 20 is a flow diagram showing example operations that may be performed by an embodiment of the information management system of FIG. 1; and

FIG. 22 is a diagrammatic illustration of example media that may be used to provide a computer program product for performing operations of the information management system of FIG. 1.

### DETAILED DESCRIPTION OF EXAMPLE EMBODIMENTS

### Introduction

The information management system described herein improves interaction between transport service users (hereinafter “users”) and transport service providers (hereinafter “providers”) in connection with the negotiation of charter transport service. The information management system supports novel functions that allow users and providers to exchange information in real time and view such information in a pictorial format overlaid on geographic maps. According to disclosed embodiments, the information management system can be based on a web and geographic information service-based architecture that manages the information exchange. This enables users to communicate specific transport mission information to plural providers. The providers may likewise view the mission information of plural users. Based on this information exchange, the providers can match their specific transport resources to specific mission requests and communicate with the users to determine the most appropriate manner to deliver the service.

As used herein, a “user” is an entity, or a representative of an entity, that desires to have a provider perform a transport mission. Conversely, a “provider” is an entity, or a representative of an entity, that desires to perform a transport mission. A “transport mission” or “mission” is a trip involving the transport of persons or goods from an origin to a destination. Typically (although not required), providers who utilize embodiments of the information management system disclosed herein will perform transport missions over large geographic areas, and will have one or more transport resources located within such areas. Examples of transport missions include, but are not limited to the transport of passengers and cargo via land, air or water, such as air ambulance transport, cargo shipping, vehicle charter, aircraft charter, watercraft charter, etc.

One particular transport mission example is a fixed wing air ambulance flight. Thus, an embodiment of the information management system disclosed herein may be applicable to the fixed wing air ambulance industry, and in general to the aviation charter industry. In the fixed wing air ambulance field, users may include hospitals or other medical care facilities, medical professionals, insurance companies, patients, patient family members, patient advocates, social workers, discharge planers, funeral directors, or other entities that have a need to transport a patient, organ, medical team, human remains, etc., utilizing a fixed wing aircraft. Providers may include air ambulance services, air ambulance brokers, air carriers and operators, or other aviation professionals with fixed wing assets available for air ambulance transport missions. In this environment, an embodiment of the information management system disclosed herein may be used to coordinate all personnel, aircraft and flights required to meet the objective of the mission.

To appreciate how the disclosed information management system may support such coordination, it will be helpful to review the conventional technique used to arrange fixed wing air ambulance missions. Presently, when a user has an identified mission, they must find a provider to provide the service. This is typically accomplished using telephone call lists, referral services, Internet searches, and other investigatory techniques. Based on the investigation, the user requests a mission quotation from the providers that were identified (which is generally a limited number). The provider typically responds with a quote within twenty-four hours and the user selects one of the providers to perform the mission. Disadvantages of this approach include, but are not limited to:
1) Excessive time consumption for both users and providers;
2) Intensive labor for both users and providers;
3) Users are exposed to a limited number of providers;
4) Providers receive requests from a limited number of users;
5) Providers must utilize aircraft in close proximity to user departure or arrival locations, thereby limiting the utilization of transport resources (aircraft); and
6) Providers have little or no information regarding successive or future missions from multiple users, preventing optimization of resource utilization.

The foregoing disadvantages add cost to the delivery of transport service and result in inefficient use of resources. As will be described in more detail below, embodiments of the disclosed information management system may be used to assist the coordination of fixed wing air ambulance service (and other types of transport missions) in a number of areas, including but not limited to:
1) Reducing the time and labor required to plan and execute missions for both users and providers;
2) Providing the capability to identify future mission requirements;
3) Optimizing the utilization of resources (e.g., aircraft, personnel, etc.);
4) Reducing overall mission costs due to optimization of resources;
5) Reducing overall fuel consumption due to optimized mission routing;
6) Reducing overall carbon emissions due to reduced fuel consumption; and
7) Reducing cost per patient due to optimized mission routing.

### EXAMPLE EMBODIMENTS

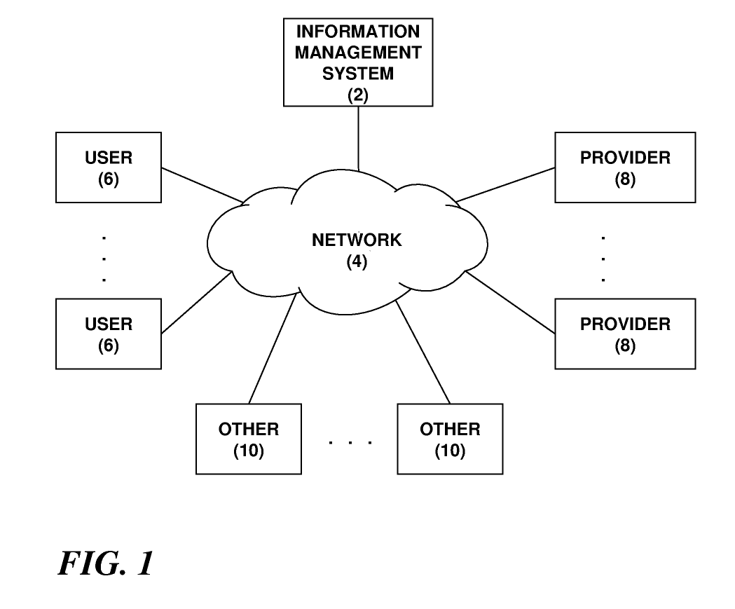

Turning now to the figures, wherein like reference numerals represent like elements in all of the several views, FIG. 1 illustrates an information management system 2 that may be used to support charter transport service in accordance with the present disclosure. As shown, the information management system 2 may be implemented as a computing node that is operatively coupled to a computer network 4 (or other communication system). The information management system 2 uses the network 4 to exchange charter transport service information with one or more computing nodes that are situated remotely from the information management system. The remote network nodes may include user nodes 6 associated with users, provider nodes 10 associated with providers, and other nodes 12 associated with independent entities that are neither users nor providers. It will be appreciated that the information management system 2 may be operated by many different types of entities, including collectives, trade associations or other groups that are affiliated with providers or users, or entities that are affiliated with neither providers or users, including an independent transport brokerage or exchange entity.

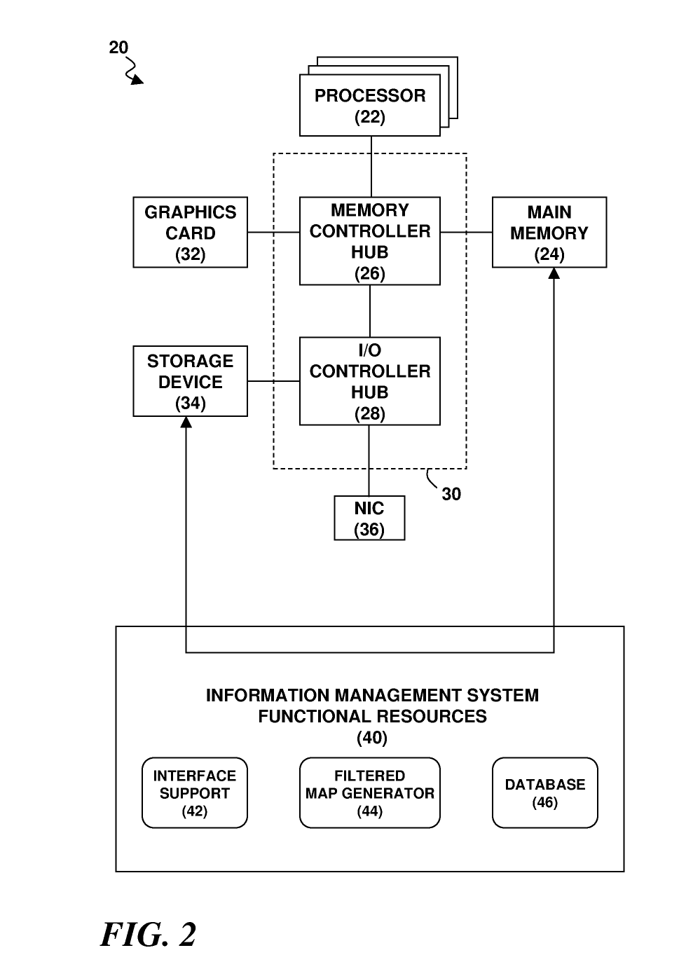

FIG. 2 illustrates an example computer system 20 that may be used as a hardware platform for the information management system 2. The computer system 20 comprises an instruction processing machine that incorporates at least one CPU (Central Processing Unit) 22 (hereinafter “processor”) and a memory 24 operatively coupled to the processor. The processor 22 may be implemented as an execution core of a single-core or multi-core microprocessor, or in any other type of instruction processing device. The memory 24 may be implemented using any type of computer readable storage medium capable of storing program instructions and data. Example memory types include, but are not limited to, static or dynamic random-access memory, semiconductor read-only or flash memory, magnetic or optical disk memory, or combinations thereof.

The processor 22 is operatively interconnected to the memory 24 by way of a memory controller 26. The memory controller 26 may be implemented in conjunction with an I/O (Input/Output) controller 28 in a chipset that provides an integrated bus infrastructure 30. Memory controller functionality could also be integrated with each of the processors 22. An optional graphics card 32 may be operatively connected to the memory controller hub 26 for generating visual output information to an optional display monitor (not shown). A peripheral storage device 34, such as a magnetic or optical disk drive, is operatively connected to the I/O controller 28. A network interface card (NIC) 36 is also operatively connected to the I/O controller 28 for communicating with the network 4 (see FIG. 1). Other peripheral devices (not shown) may be added as required.

Persons skilled in the art will appreciate that the computer system 20 may be implemented in many other ways, and may include additional components that are known in the art. Such alternative implementations and additional components will not be described in the interest of brevity and in order not to obscure the disclosed subject matter.

With continued reference to FIG. 2, the computer system 20 implements a set of functional logic resources 40 that support the operative functions of the information management system. 2. The functional resources 40 can be implemented in any suitable fashion, including software, firmware, hardware logic, and any combination of the foregoing. FIG. 2 illustrates one example wherein the functional resources 40 are implemented as software that can stored on the storage device 34 and loaded into the main memory 24 during operation of the computer system 2. The functional resources 40 may thus tangibly embody a program of instructions (together with related data) that are processed during system operations. The program of instructions is executable by the processor 22 to configure electronic logic circuitry within the computer system 20 to assume logic states that perform particular machine operations. For example, the program instructions provided by the functional resources 40 may control the computer system 20 so that the information management system 2 operates as a web server (website) that the nodes 6, 8 and 10 can access using a conventional web browser.

As stated by way of introduction above, the information management system 2 supports novel functions that allow users and providers to exchange transport mission information in real time and view such information in a pictorial format overlaid on geographic maps. To that end, the functional resources 40 may include interface support logic 42, a filtered map generator 44, and a database or other data store 46. The interface support logic 42 provides interfaces that allow users and providers to interact with the information management system 2. The map generator 44 represents an extension of the interface support logic 42 that is responsible for generating geographic maps that illustrate transport missions. The database 46 can be used to store information relating to mission requests made by users and mission quotations made by providers, and to maintain other desired information. Additional operations of the interface support logic 42, the map generator 44, and the database 46 will be described in more detail below.

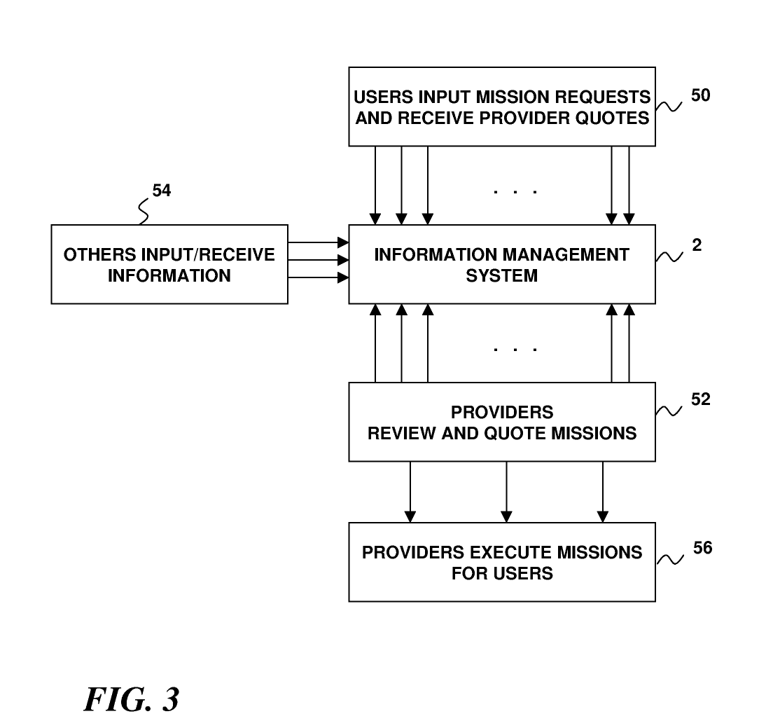

FIG. 3 illustrates how the information management system 2 serves as a real-time information coordinator for supporting interactions between transport users and providers. As shown in block 50, users input mission requests (a.k.a. requests for quote or RFQs) to the information management 2. In response to the mission requests, users receive price quotations from providers. As shown in block 52, providers review mission requests from users using a convenient graphical paradigm, and provide price quotations for missions that may be of interest. As shown in block 54, other parties may submit and receive information to or from the information management system 2. As shown in block 56, providers will periodically execute missions for users based on the real-time information exchange facilitated by the information management system 2.

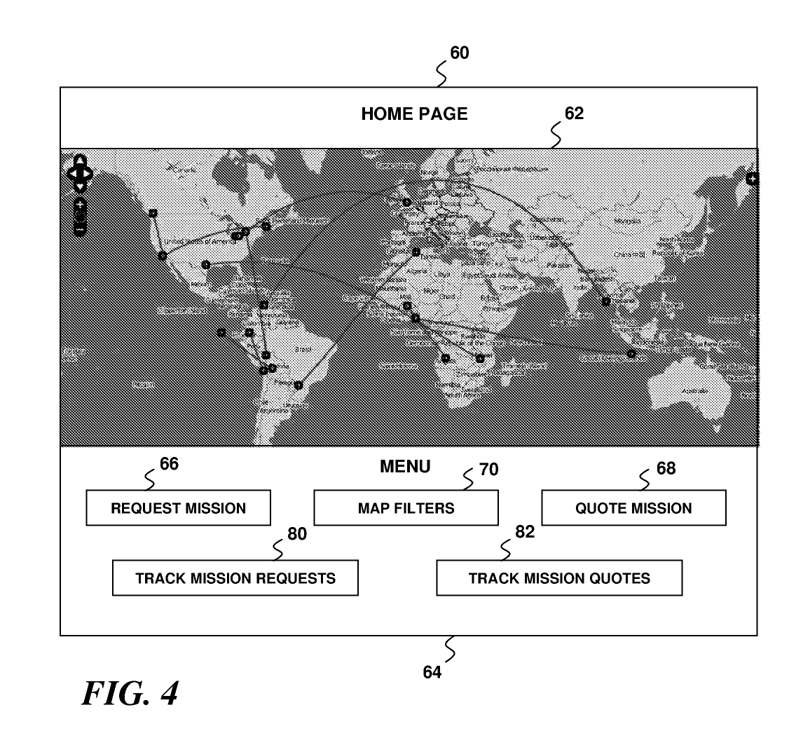

Turning now to FIG. 4, an example main interface (home page) 60 is shown that may be generated by the interface support logic 42 and accessed by the nodes 6, 8 and 10 via the network 4 (see FIG. 1). In particular, if the information management system 2 is implemented as a web server (website), the main interface 60 may be generated as a web page that is accessed in conventional fashion using a URL (Uniform Resource Locator) and served (downloaded) for display in a web browser (not shown). As shown, the main interface 60 may include a map window 62 and a menu 64 containing a set of menu selections. It will be appreciated that FIG. 4 is illustrative of only one possible interface configuration, and that many other configurations would also be possible in keeping with the present disclosure.

The map 62 is dynamically generated by the map generator 44. In FIG. 4, the map window 62 displays the image of a global map that illustrates transport missions between various cities. Deadhead legs representing transport resources scheduled to travel empty or with available room for persons or goods may also be depicted. Each mission (or deadhead leg) may be shown as a vector extending between an origin and a destination. In FIG. 4, the vectors depict great circle routes, but this is not a requirement. The vectors may or may not include arrowheads, depending on design preferences. The illustrated missions (or deadhead legs) represent trips that will occur relative to a default time frame, such as all trips that will be made within the next 72 hours. The default time frame can be set by the map generator 44. As described in more detail below, other time frames may be specified during interaction with information management system 2.

The menu 64 may include any number of desired menu selections. By way of example only, FIG. 4 illustrates a request mission selection 66, a quote mission selection 68, a map filter selection 70, a track mission requests selection 80, and a track mission quotes selection 82. The request mission selection 66 allows users to interact with the information management system 2 for the purpose of submitting mission request information. The quote mission selection 68 allows providers to interact with the information management system 2 for the purpose of quoting missions that have been requested by users. The map filter selection 70 allows users, providers and others to change the map content of the map window 62 to depict different information, such as maps for different geographic regions and time frames (as described in more detail below). The track mission requests selection 80 allows users to quickly check for mission quotations from providers. The track mission quotes selection 82 allows providers to quickly check for mission quotation acceptances from users. It will be appreciated that each of the foregoing selections may be implemented using any suitable type of graphical user interface object, such as buttons, pull-down menus, hyperlinks, etc., or various combinations thereof. Moreover, as is typical with interfaces of this type, the functions that are accessible using the menu 64 may also be accessed from other contexts, such as redundant graphical user interface objects provided within other interfaces that can be navigated to from the main interface 60.

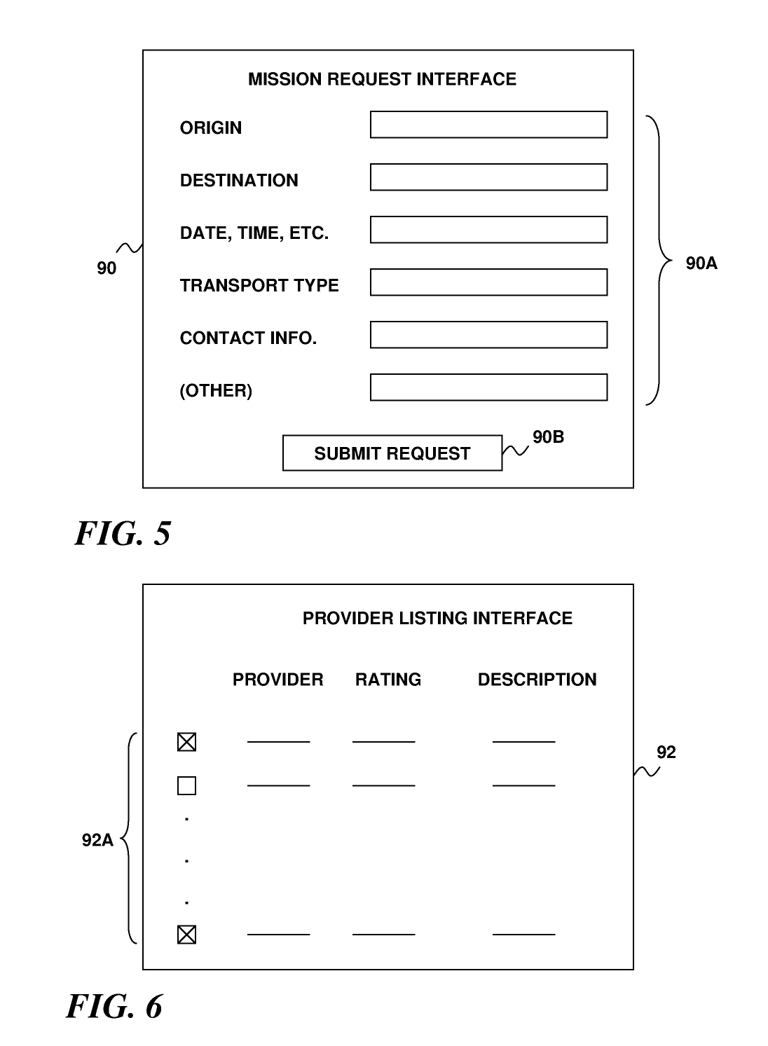

Turning now to FIG. 5, a mission request interface 90 is shown that may be generated by the interface support logic 42 in response to activation of the request mission selection 66 of FIG. 4. The mission request interface 90 includes labeled text entry fields 90A (or other graphical user interface objects) that allow users to input specific information regarding a particular mission. As shown, the mission information may include a mission origin, a mission destination, and a mission time frame. The mission origin and destination may be specified as a city, an airport, or using other geographic locators. The mission time frame can be specified in various ways, including but not limited to, date, time, date range, time range, or any other interval. A specification of date and time would usually be provided together, such as May 14, 2008 at 6:00 a.m. A date range would include starting and ending dates, such as May 14, 2008-May 15, 2008. A time range would include starting and ending times, such as 6:00 a.m.-6 p.m., and would usually be specified in conjunction with a date or date range. A mission time frame could also be specified as some number of hours, days, weeks, etc., from a current date and/or time. For example, within the next 24 hours, 48 hours or 72 hours, within the next week, within the next month, next Monday, Wednesday or Friday, no later than Jun. 15, 2008, etc. It will be appreciated that the broader the time frame the more flexibility the provider will have in delivering resources to the user.

The mission information that may be input via the mission request interface 90 may also include transport asset type (e.g., fixed wing aircraft size, engine number and type, etc.), user contact information, and any other relevant information, such as special requirements and other mission details, how payment will be made, etc. For example, for a fixed wing air ambulance mission, the transport requirements could include patient condition, in-flight medical staff needs, in-flight equipment needs, etc. The mission request interface 90 also includes a submit request selection 90B for submitting the input mission request information to the information management system 2. Activation of the submit request selection 90B causes the interface support logic 42 to store the mission information in the database 46 of FIG. 2. Submitting a mission request may also result in the interface support logic 42 assigning a mission request number for reference purposes. The database 46 can be designed to allow searching of accumulated mission requests according to any number of relevant mission characteristics, including origin, destination, time frame, user information, whether or not the mission has been accepted, etc.

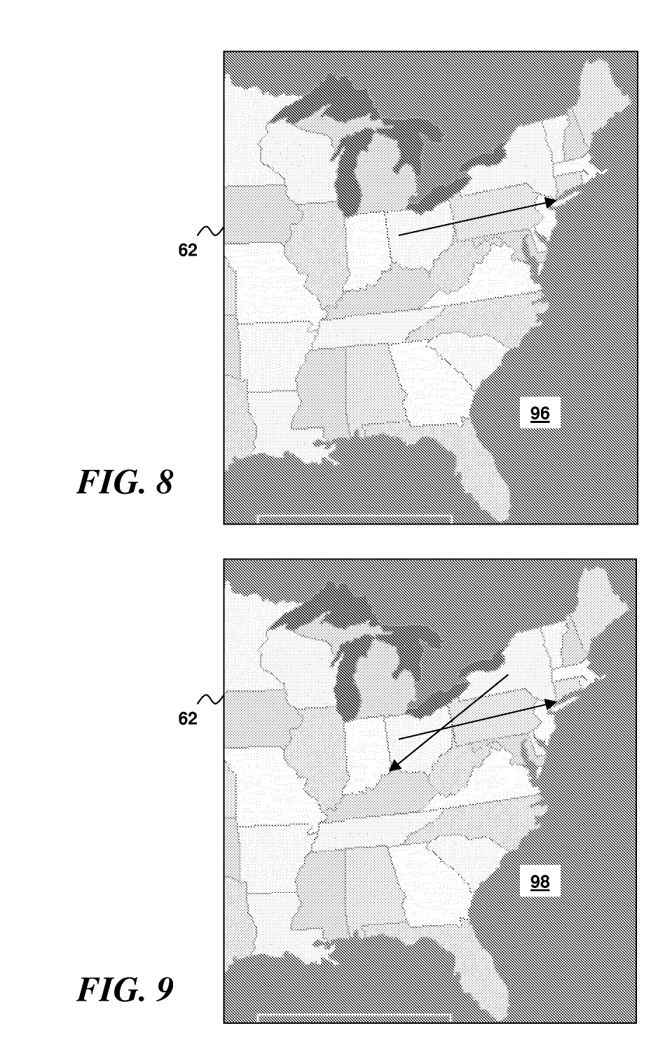

Turning now to FIG. 6, an optional provider listing interface 92 is shown that may also be generated by the interface support logic 42 in response to activation of the request mission selection 66 of FIG. 4, or alternatively, in response to activation of the submit request selection 90B of FIG. 5. The provider listing interface 92 provides an opportunity for users to obtain information about providers and select the providers that are of interest. The selected providers may then be directly send mission requests via email or by other message means. The message sent to the provider will include some or all of the quote information, and may also include a link to a map generated by the map generator 44, such as the map shown in FIG. 8. The provider listing interface 92 includes a provider selection 92A for each listed provider, together with associated provider identifying information, such as a provider name, a provider rating, and a provider description. Additional information may also be accessible from the provider listing interface 92, such as a link to each provider's web site and a link to a user comments section (not shown) of the information management system 2 that allows users to view and make comments regarding providers. The latter information could be used to generate the provider ratings. Ratings could also be based in whole or in part on information provided by certification bodies, other organizations, or by the information management system 2 itself. Given the provider information that may be obtained from the provider listing interface 92, it will be appreciated that the information management system 2 performs a marketplace function wherein providers can identify themselves and promote their products and services to users. Useful information such as provider logos, company names, addresses, telephone numbers, email addresses, website addresses, brochures, credentials, pictures/images, customer ratings and validations, association ratings, certifications and licenses, can all be made available to assist in provider selection. It will also be appreciated that the information management system 2 may also support the display of advertisements or other promotional information from users or from other parties that are neither users or providers (e.g., fixed wing air aircraft manufacturers, in-flight medical equipment suppliers, etc.).

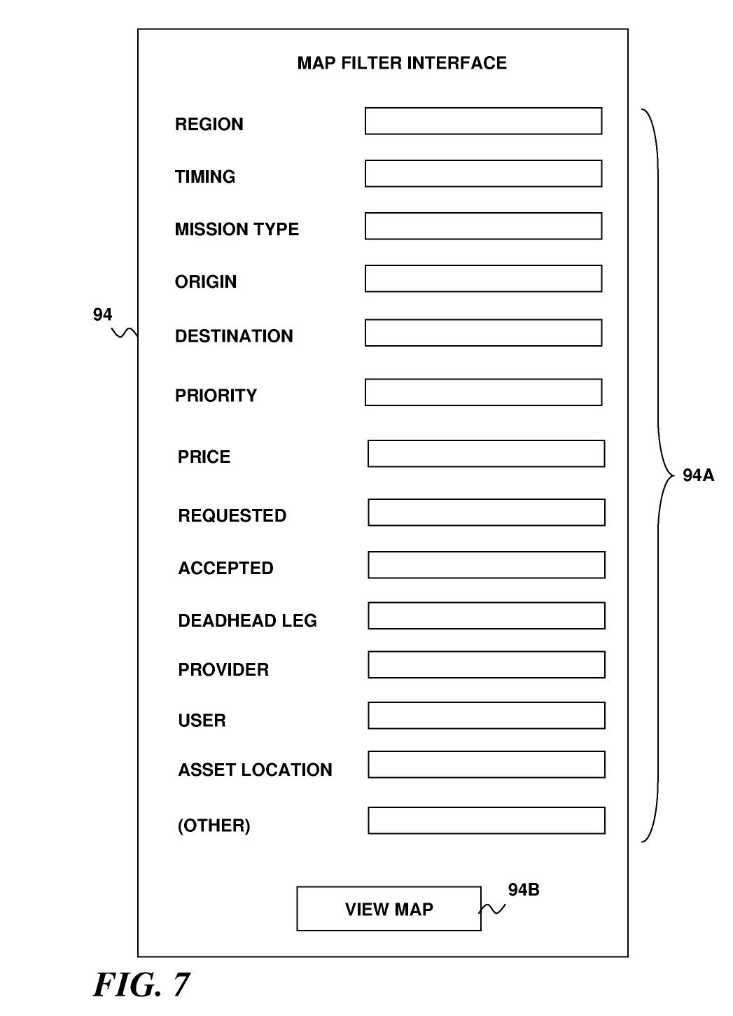

Turning now to FIG. 7, a map filter interface 94 is shown that may be generated by the interface support logic 42 in response to activation of the map filter selection 70 of FIG. 4. The map filter interface 94 includes labeled text entry fields 94A (or other graphical user interface objects) that allow users, providers or anyone else to specify filter data to the map generator 44 of FIG. 2. As shown, the map filter data may include one or more of geographic region, mission time frame, mission type, mission origin, mission destination, mission priority (e.g., patient condition for fixed wing air ambulance missions), mission price range, requested missions, accepted missions, deadhead legs, provider information, user information, provider asset location, and any other desired filter information. A view map selection 94B may also be provided to display a map based on the filter information. Although not shown, provision can be made for storing map filter specifications on behalf of users, providers and other entities that access the information management system 2. This feature would help viewers track changes that occur over time relative to a fixed set of filter criteria without having to re-enter filter settings. If the information management system 2 is implemented as an account-based system, account-holders could store map filter specifications along with other account settings.

FIG. 8 illustrates one example of a filtered map 96 that may be displayed in the map window 62 of FIG. 4 (or in any other window). For purposes of illustration, assume that the map 96 represents fixed wing air ambulance missions requested within the next 6 hours in the eastern United States. As can be seen, a single flight has been requested from Dayton, Ohio, to New York, N.Y. Assuming a provider has a fixed wing air ambulance asset available to service this mission, the provider may wish to respond to the mission request. This of course, will depend on whether or not the mission request is still pending and has not already been successfully awarded to another provider. Thus, another feature of the map generator 44 is that it may be programmed to display mission vectors in different ways to distinguish between missions that have merely been requested and missions that have been accepted (but not yet executed). For example, although not shown in the drawing figures, different colors, line weights, line types, etc., could be used to represent the mission status.

FIG. 9 illustrates another example of a filtered map 98 that may be displayed in the map window 62 of FIG. 4 (or in any other window). For purposes of illustration, assume that the map 98 represents fixed wing air ambulance missions requested within the next 12 hours in the eastern United States. In addition to the information shown in the map 96 of FIG. 8, another flight has been requested from Syracuse, N.Y. to Cincinnati, Ohio. Assuming a provider has a fixed wing air ambulance asset available to service one or both missions, the provider may wish to respond to the mission request(s). Advantageously, the provider can more accurately quote the missions than may be possible if the mission requests were received using conventional user/provider interaction mechanisms. For example, it is typical for a fixed wing air ambulance provider to dedicate an entire day to a mission, thereby transporting one patient per day. Due to a variety of factors, this effectively commits one aircraft to one patient per day. In contrast, using the map 98, a provider could plan a morning flight for the Syracuse-Cincinnati mission and an afternoon flight for the Dayton-New York mission, thereby reducing costs by limiting the trip to a single day.

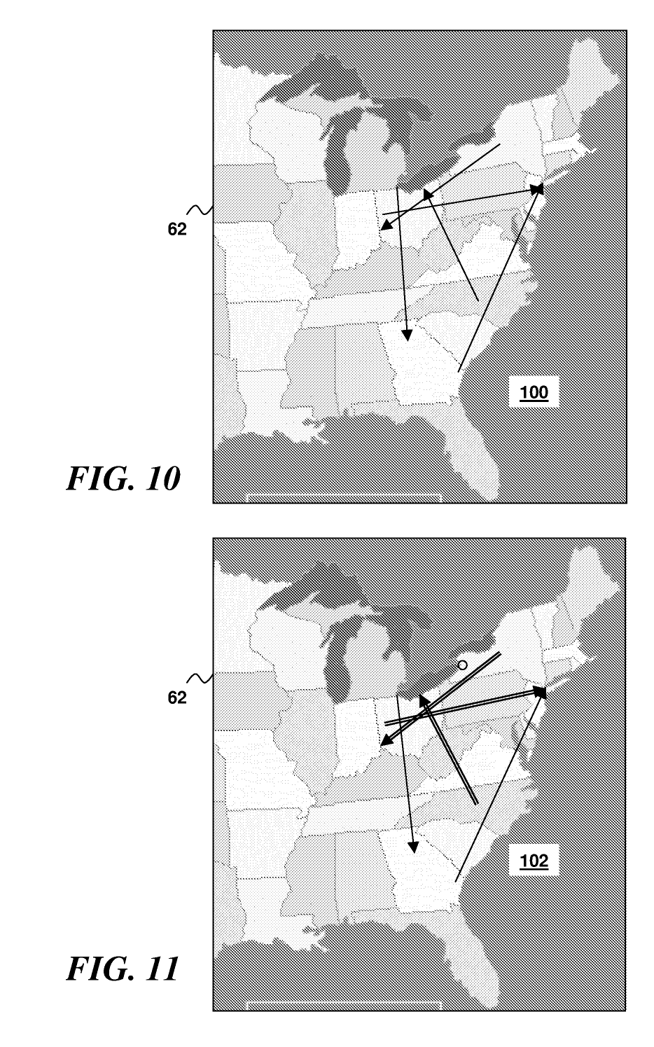

FIG. 10 illustrates another example of a filtered map 100 that may be displayed in the map window 62 of FIG. 4 (or in any other window). For purposes of illustration, assume that the map 100 represents fixed wing air ambulance missions requested within the next 24 hours in the eastern United States. In addition to the information shown in the map 98 of FIG. 9, additional flights have been requested from Toledo, Ohio to Atlanta, Ga., from Savannah, Ga. to New York, N.Y., and from Charlotte, N.C. to Cleveland, Ohio. Assuming a provider has a fixed wing air ambulance asset available to service one or more of these missions, the provider may wish to link together one or more of these additional mission request(s) to plan a longer trip involving additional cities.

FIG. 11 illustrates another example of a filtered map 102 that may be displayed in the map window 62 of FIG. 4 (or in any other window). The map 102 is similar to the map 100 of FIG. 10, except that an additional filter has been specified. In particular, a provider who requested the map 102 has used the asset location filter selection of the map filter interface 94 (FIG. 7) to indicate that the provider has a fixed wing air ambulance asset located in Buffalo, N.Y. The map generator 44 (FIG. 2) can be programmed to use this filter data to depict the asset location in the map 102 (e.g., as a small circle or other symbol). In addition, the map generator 44 can be programmed to highlight (in any suitable fashion) fixed wing air ambulance missions that are feasible using the identified asset. Feasibility may be determined based on a distance from the asset location that is deemed to be serviceable using the asset. This distance may be specified by the provider (e.g., as part of the provider asset location filter information). A pre-programmed or calculated distance could also be used by the map generator 44 based on asset type. Alternatively, the provider could simply select feasible fights by interacting with the map 104 using a cursor or keyboard operation. In FIG. 11, the feasible flights are highlighted by double-line vectors. These vectors correspond to the missions from Syracuse, N.Y. to Cincinnati, Ohio, from Dayton, Ohio to New York, N.Y., and from Charlotte, N.C. to Cleveland, Ohio. The feasibility information can assist a provider quickly identify potential missions for specific assets.

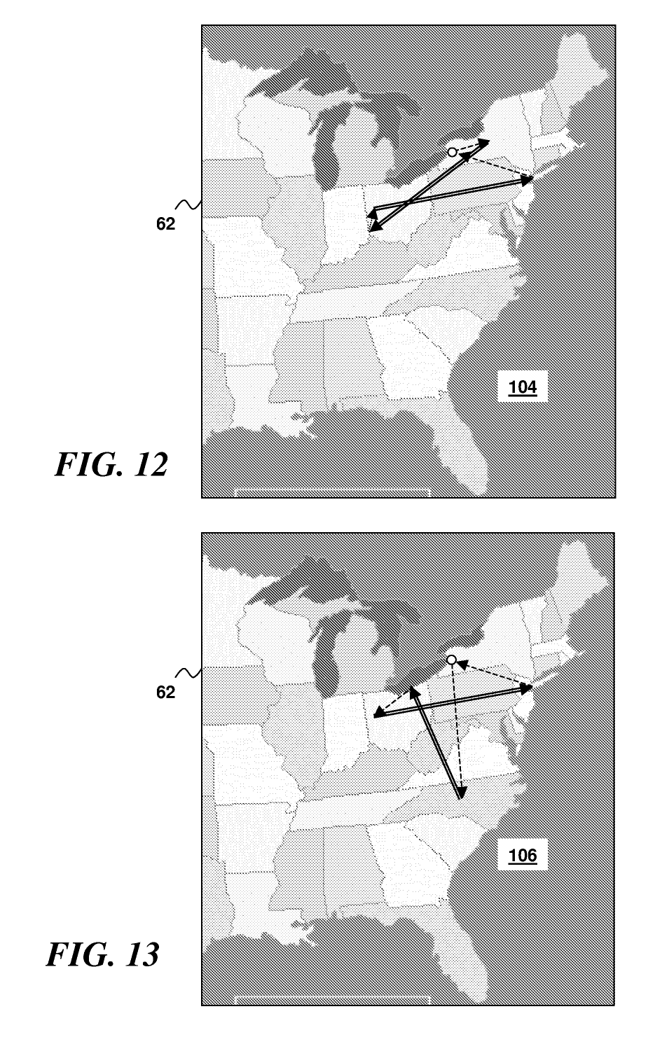

FIG. 12 illustrates another example of a filtered map 104 that may be displayed in the map window 62 of FIG. 4 (or in any other window). The map 104 is similar to the map 102 of FIG. 11, except that an additional filter has been specified. In particular, a provider who requested the map 104 has used the deadhead leg filter selection of the map filter interface 94 (FIG. 7) to show deadhead legs for the provider asset located in Buffalo, N.Y. if the provider performs the missions from Syracuse, N.Y. to Cincinnati, Ohio and from Dayton, Ohio to New York, N.Y. As can be seen, one deadhead leg is from Buffalo, N.Y. to Syracuse, N.Y. to start the mission from Syracuse, N.Y. to Cincinnati, Ohio. Another deadhead leg is from Cincinnati, Ohio to Dayton, Ohio to start the mission from Dayton, Ohio to New York, N.Y. A final deadhead leg is from New York, N.Y. to Buffalo, N.Y. to return the asset to its starting point. The deadhead legs are shown as dashed line vectors. Other highlighting techniques could also be used, such as a designated color.

Note that a distinction can be made between a potential deadhead leg that does not yet exist in fact because the provider has not yet booked missions, and an actual deadhead leg that exists after the provider has committed to the missions. Different color schemes or other graphical techniques may be used to distinguish between potential and actual deadheads. Potential deadhead leg information that is displayed by the map generator 44 can be used by a provider to link together missions and deadhead legs to plan a trip for a specific asset (representing a route optimization plan), and thereby more accurately determine mission pricing. Alternatively, instead of displaying potential deadhead legs, it would be possible to display only mission requests and allow the provider to determine the deadheads relative to particular assets without use of a map. Actual deadhead leg information displayed by the map generator 44 can be used by users to identify open flights that a provider would likely be willing to fill. The user could potentially receive a discount by utilizing a deadhead leg that a provider has already scheduled.

FIG. 13 illustrates another example of a filtered map 106 that may be displayed in the map window 62 of FIG. 4 (or in any other window). The map 106 is similar to the map 104 of FIG. 11, except that other feasible flights are highlighted and corresponding deadhead legs are shown relative to the Buffalo, N.Y. asset. The missions are from Dayton, Ohio to New York, N.Y., and from Charlotte, N.C. to Cleveland, Ohio. The deadhead legs are from Buffalo, N.Y. to Charlotte, N.C., from Cleveland, Ohio to Dayton, Ohio, and from New York, N.Y. back to the asset starting point in Buffalo, N.Y. This information can be used by a provider to plan an alternative trip that links together different missions and deadhead legs (representing another route optimization plan), then rank the trips according to expected profitability. This could be determined by the number and length of the deadhead legs. FIGS. 12 and 13 each have three deadhead legs, but the deadhead leg distance traveled is less in FIG. 12. Thus, the provider may prefer the FIG. 12 trip over the FIG. 13 trip.

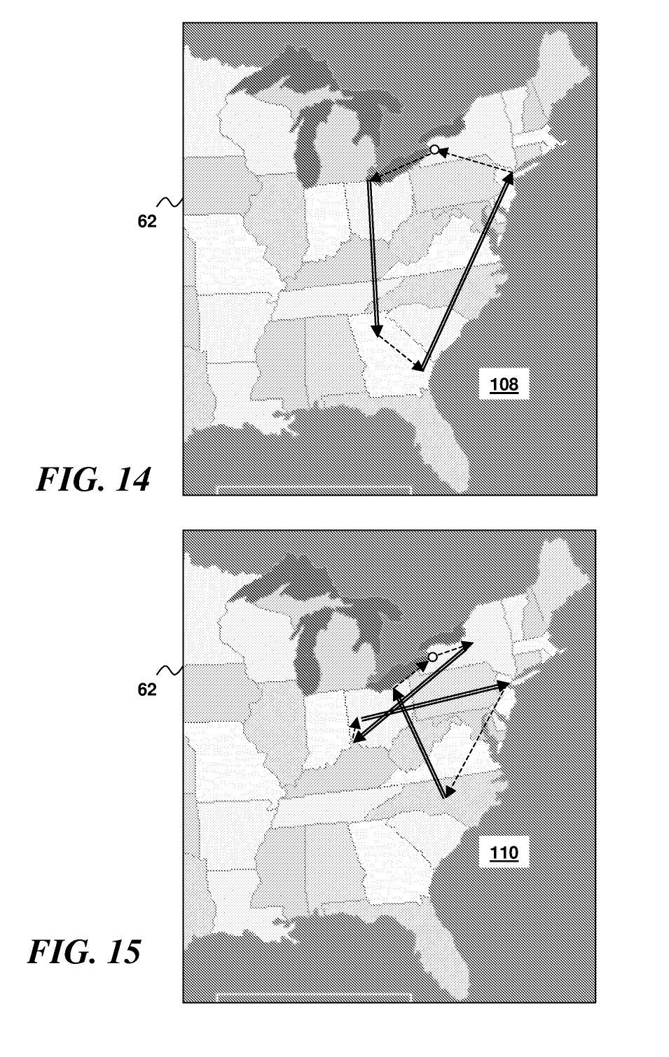

FIG. 14 illustrates another example of a filtered map 108 that may be displayed in the map window 62 of FIG. 4 (or in any other window). The map 108 is similar to the map 106 of FIG. 13, except that other feasible flights are highlighted and corresponding deadhead legs are shown relative to the Buffalo, N.Y. asset. The missions are from Toledo, Ohio to Atlanta, Ga. and from Savannah, Ga. to New York, N.Y. The deadhead legs are from Buffalo, N.Y. to Toledo, Ohio, from Atlanta, Ga. to Savannah, Ga., and from New York, N.Y. back to the asset starting point in Buffalo, N.Y. This information can again be used by a provider to plan another alternative trip (representing another route optimization plan), that links together different missions and deadhead legs, then rank the trips according to expected profitability. Note that the overall length of the deadhead legs is larger than in FIG. 12. However, the missions are longer and thus possibly more profitable.

FIG. 15 illustrates another example of a filtered map 110 that may be displayed in the map window 62 of FIG. 4 (or in any other window). The map 110 is similar to the map 108 of FIG. 13, except that other feasible flights are highlighted and corresponding deadhead legs are shown relative to the Buffalo, N.Y. asset. The missions are from Syracuse, N.Y. to Cincinnati, Ohio, from Dayton, Ohio to New York, N.Y., and from Charlotte, N.C. to Cleveland Ohio. The deadhead legs are from Buffalo, N.Y. to Syracuse, N.Y., Cincinnati, Ohio to Toledo, Ohio, New York, N.Y. to Charlotte, N.C., and Cleveland, Ohio back to the asset starting point in Buffalo, N.Y. This information can again be used by a provider to plan another alternative trip involving different missions, representing another route optimization plan, then rank the trips according to expected profitability. Note that the overall length of the deadhead legs is larger than in FIG. 12. However, there is one more mission, which may increase profitability.

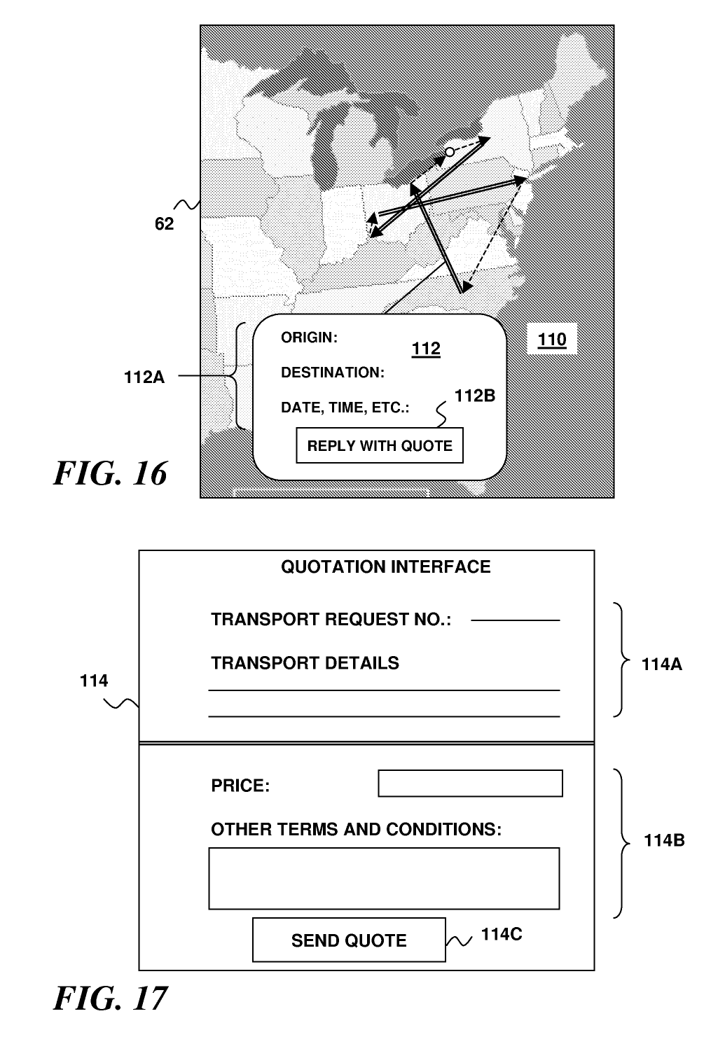

FIG. 16 illustrates the map 110 of FIG. 15, and additionally depicts an example interactive technique that may be used to generate additional mission information (in text form) to augment the graphical mission vector representations shown in the map. In particular, a pop-message 112 has been generated following selection of the Charlotte-to-Cleveland mission vector using a mouse or keyboard operation (e.g., a right mouse click). The pop-up message 112 displays mission information 112A that may include further details about the mission origin and destination as well as other information such as mission time frame. The mission time frame information would be used by providers in linking together mission vectors to plan trips. As an alternative to using this approach, the mission time frame information could also be displayed in text that is displayed with the mission vector, thereby obviating the need to perform a mouse or keyboard operation to view the mission time frame. The mission information 112A may also contain additional information input by the user in the mission request interface 90 of FIG. 5 (or it may contain all of such information). As shown in FIG. 16, the pop-up display may also provide a reply with quote selection 112B that a provider may use to quote a mission.

FIG. 17 illustrates a quotation interface 114 that may be used by a provider to prepare and submit a mission quotation to a user. The quotation interface may be generated by the interface support logic 42 in response to activation of the reply with quote selection 112B of FIG. 16, and in response to activation of the quote mission selection 68 in FIG. 4. A first portion 11 4A of the quotation interface 114 may contain mission information as input by a user in the mission request interface 90 of FIG. 6. A mission request number may also be displayed, if previously assigned by the interface support logic 42 for tracking mission requests. A second portion 114B of the quotation interface may contain relevant mission quotation information input by a provider, such as pricing and other terms and conditions. A send quote selector 114C may be used to submit the quote to the user. The interface support logic 42 can submit the quote in any suitable fashion, such as via email. In that regard, it will be appreciated that the quotation interface 114 could itself be an email message drafting interface generated by an email client (not shown) invoked by the interface support logic 42. The interface support logic 42 could also submit a quote by storing in the database 46 (FIG. 2) and later presenting it when a user activates the track mission requests selection 80 of FIG. 4.

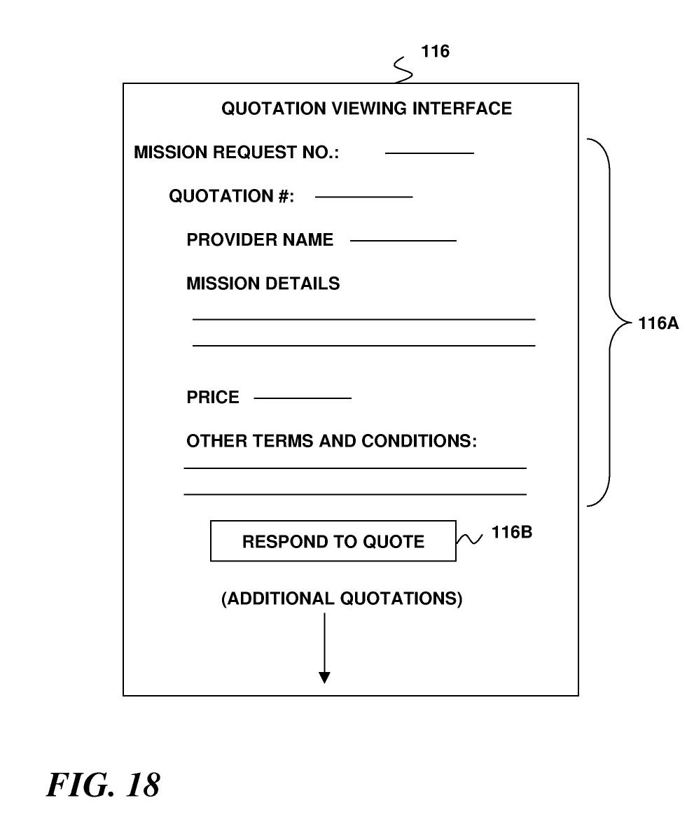

FIG. 18 illustrates a quotation viewing interface 116 that may be used by a user to view quotations that it has received from one or more providers. This interface can be accessed via the track mission requests selection 80 of FIG. 4. The quotations may include quotation information 116A that includes mission request number, a quotation number, a provider name, mission details, pricing and other terms and conditions, such as specific departure and arrival times. A quote response selection 116B can be provided for each quotation so that the user can respond to the best quote. Selecting the selection 116B may result in the interface support logic 42 sending an email response to the provider. Alternatively (or in addition), the quote response could be stored in the database 46 (FIG. 2) and the provider could check for the response using the track mission quotes selection 82 of FIG. 4.

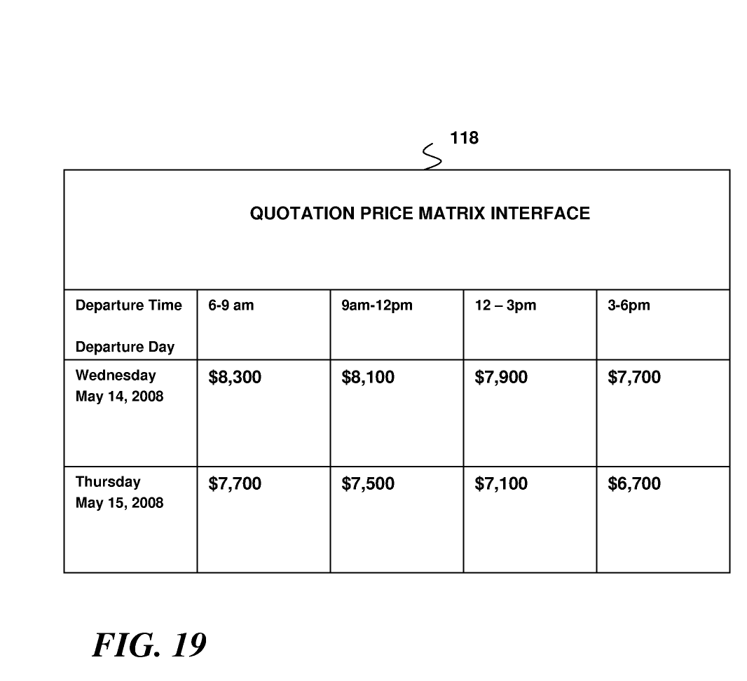

FIG. 19 illustrate a quotation price matrix interface 118 that may be used by a user to view a matrix of quotations from multiple providers. In the example of FIG. 19, the user has requested quotations for a mission that has a two-day time window, and has received quotations for each day and for different departure times. Note that by specifying a date range, the user offers providers greater flexibility in departure date and time, which should lower costs. Note that the illustrated quotations might all be from the same provider or from different providers. A suitable mouse or keyboard action (such as a right mouse click) could be used to obtain additional information regarding each quotation. The user may respond by performing a user interface action with respect to a selected quotation, such as double-clicking with a mouse. This could result in an email response being sent to the provider. Alternatively (or in addition), the quote response could be stored in the database 46 (FIG. 2) and the provider could check for the response using the track mission quotes selection 82 of FIG. 4.

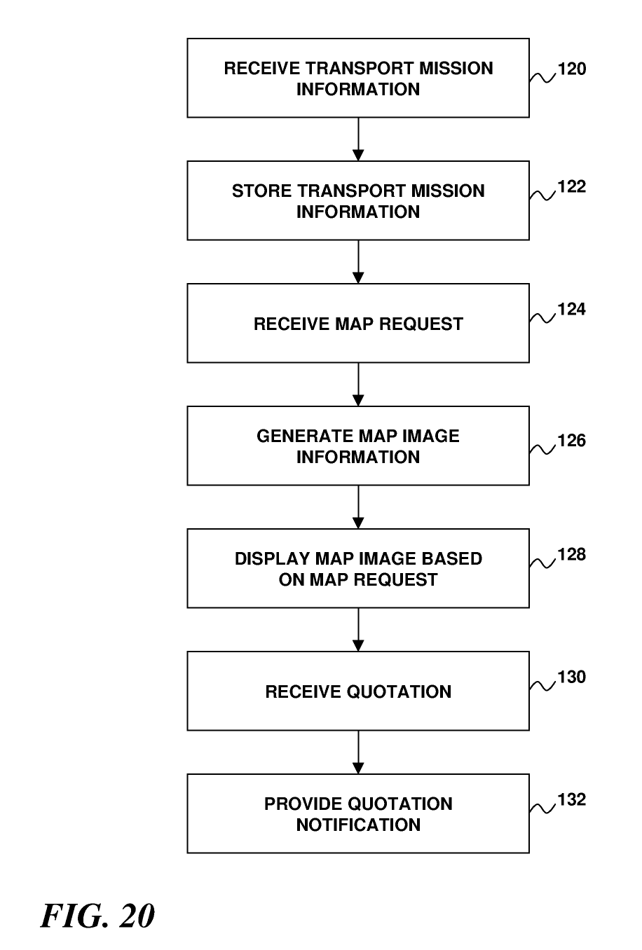

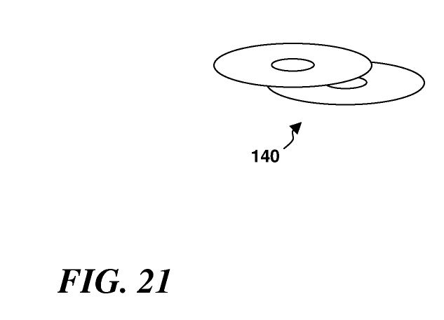

Turning now to FIG. 20, a flow diagram is shown to illustrate operations that may be performed by the information management system 2 to support interactions between a user and a provider. In block 120, the information management system 2 receives a mission request, and in block 122 the mission request is stored in the database 46 (FIG. 2). In block 124, the information management system 2 receives a map request, and in block 126 generates map image information for use in displaying the requested map. By way of example, the map image information may comprise a web page suitable for transmission over the network 4 (FIG. 1). In block 128, an output operation is performed that results in remote or local display of a map image based on the map image information. For example, the map image information could be sent via the network 4 to any of the nodes 6, 8 or 10 of FIG. 1 and displayed by a web browser. Alternatively, the map could be generated and displayed locally at the information management system assuming the computer system 20 (FIG. 2) has graphical display capability. As discussed, the map image will depict a geographic region (which could span the entire globe or any lesser portion thereof) and a graphical representation of a mission showing an origin and a destination for one or more transport missions whose origin and destination are within the geographic region. In block 130, the information management system receives a quotation for a mission and stores it in the database 46. Notification of the quotation may then be given to the user in block 132.

Accordingly, a charter transport service information management system and related method have been disclosed. The system and method provide a convenient way for transport providers to display requested missions in real time and visually match the missions with the locations of provider resources (e.g. aircraft). Utilizing a computer cursor or the like, a provider can select one or more vectors representing missions in order to be presented with specific additional information regarding the missions. Given the time frames involved, the provider may initiate multiple quotes to multiple users at one time. In addition, given the time frames, departure and arrival points and location of resources (e.g., aircraft), the provider may be able to link together several missions within a given time frame, thereby improving resource utilization. Benefits for users include easy, efficient and timely booking of missions. Benefits for providers include real-time visualization of requested missions, an efficient and timely quotation process, optimal mission asset routing, lower costs, and potentially higher profit margins.

It will be appreciated that the foregoing concepts may be variously embodied in any of a computer system or other instruction processing machine, a machine implemented method, and a computer program product in which digitally encoded program instructions are stored on one or more computer-readable data storage media for use in controlling a computer or other instruction processing machine to perform the required functions. The program instructions may comprise machine language code that is ready for loading and execution by the machine, or the program instructions may comprise a higher level language that can be assembled, compiled or interpreted into machine language. Example high level languages include, but are not limited to assembly, C, C++, Java, to name but a few. When implemented on a machine comprising a CPU, the program instructions combine with the CPU to provide a particular machine that operates analogously to specific logic circuits, which themselves could be used for the invention.

Example data storage media for storing program instructions of a computer program product are shown by reference numeral 140 in FIG. 21. The media 140 are shown as being portable optical storage disks of the type that are conventionally used for commercial software sales, such as compact disk-read only memory (CD-ROM) disks, compact disk-read/write (CD-R/W) disks, and digital versatile disks (DVDs). Such media can store the program instructions of the invention either alone or in conjunction with another software product that incorporates the required functionality. The media could also be provided by portable magnetic media (such as floppy disks, flash memory sticks, etc.), or magnetic media combined with drive systems (e.g. disk drives), or media incorporated in data processing platforms, such as random access memory (RAM), read-only memory (ROM) or other semiconductor or solid state memory. More broadly, the media could comprise any electronic, magnetic, optical, electromagnetic, infrared, semiconductor system or apparatus or device, transmission or propagation or signaling medium, or any other entity that can contain, store, communicate, propagate or transport the program instructions for use by or in connection with an instruction processing system, apparatus or device, such as a computer. For all of the above forms of media, when the program instructions are loaded into and executed by an instruction processing system, apparatus or device, the resultant programmed system, apparatus or device becomes a particular machine for practicing embodiments of the method and system as described herein.

While various embodiments of the invention have been described, it should be apparent that many variations and alternative embodiments could be implemented in accordance with the invention. It is understood, therefore, that the invention is not to be in any way limited except in accordance with the spirit of the appended claims and their equivalents.

What is claimed is:

1. A method for supporting interactions between charter transport service providers and service users using an information management system, said information management system establishing a real-time information exchange website that allows transport service users to request transport missions and transport service providers to view said mission requests in a pictorial format that assists said providers in offering mission quotations.

2. The method of claim 1 wherein said information management system:
receives mission information from said users specifying a mission origin, a mission destination and a mission time frame for said missions;
processes said mission information to generate a web page for a map image that depicts a geographic region and a mission vector representation for one or more of said transport missions requested for a particular time frame whose mission origin and mission destination are within said geographic region; and
performs a map image output operation that includes serving said web page for display of said map image to one of said providers.

3. The method of claim 2, further including said information management system receiving filter data from said provider that is used to generate said web page so that said map image contains information that is pertinent to said provider.

4. The method of claim 3, wherein said filter data includes said geographic region and said time frame.

5. The method of claim 3, wherein said filter data includes a provider asset location that is depicted in said map image to allow said provider to match said asset location with nearby missions.

6. The method of claim 2, wherein said web page is programmed to present specific information regarding a mission in response to selection of a vector corresponding to said mission using a computer cursor.

7. A system for supporting interactions between charter transport service providers and service users comprising an information management system implementing a real-time information exchange website that allows transport service users to request transport missions and transport service providers to view said mission requests in a pictorial format that assists said providers in offering mission quotations.

8. The system of claim 7 wherein said information management system operates said website to:
receive mission information from said users specifying a mission origin, a mission destination and a mission time frame for said missions;
process said mission information to generate a web page for a map image that depicts a geographic region and a mission vector representation for one or more of said transport missions requested for a particular time frame whose mission origin and mission destination are within said geographic region; and
perform a map image output operation that includes serving said web page for display of said map image to one of said providers.

9. The system of claim 8, wherein said information management system operates said website to receive filter data from said provider that is used to generate said web page so that said map image contains information that is pertinent to said provider.

10. The system of claim 9, wherein said filter data includes said geographic region and said time frame.

11. The system of claim 9, wherein said filter data includes a provider asset location that is depicted in said map image to allow said provider to match said asset location with nearby missions.

12. The system of claim 8, wherein said web page is programmed to present specific information regarding a mission in response to selection of a vector corresponding to said mission using a computer cursor.

13. A computer program product, comprising:
one or more computer-readable media;
program instructions stored on said one or more media for programming a computer to operate as an information management system, said information management system establishing a real-time information exchange website that allows transport service users to request transport missions and transport service providers to view said mission requests in a pictorial format that assists said providers in offering mission quotations.

14. The computer program product of claim 13 wherein said information management system:
receives mission information from said users specifying a mission origin, a mission destination and a mission time frame for said missions;
processes said mission information to generate a web page for a map image that depicts a geographic region and a mission vector representation for one or more of said transport missions requested for a particular time frame whose mission origin and mission destination are within said geographic region; and
performs a map image output operation that includes serving said web page for display of said map image to one of said providers.

15. The computer program product of claim 14, wherein said information management system receives filter data from said provider that is used to generate said web page so that said map image contains information that is pertinent to said provider.

16. The computer program product of claim 15, wherein said filter data includes said geographic region and said time frame.

17. The computer program product of claim 15, wherein said filter data includes a provider asset location that is depicted in said map image to allow said provider to match said asset location with nearby missions.

18. The computer program product of claim 14, wherein said web page is programmed to present specific information regarding a mission in response to selection of a vector corresponding to said mission using a computer cursor.

19. A method for supporting interactions between charter transport service providers and service users using an information management system, comprising:
said information management system establishing a real-time information exchange website that allows transport service users to request transport missions and transport service providers to view said mission requests in a pictorial format that assists said providers in offering mission quotations;
said information management system receiving mission information from said users specifying a mission origin, a mission destination and a mission time frame for said missions;
said information management system processing said mission information to generate a web page for a map image that depicts a geographic region and a mission vector representation for one or more of said transport missions requested for a particular time frame whose mission origin and mission destination are within said geographic region;
said information management system performing a map image output operation that includes serving said web page for display of said map image to one of said providers;
said information management system receiving filter data from said provider that is used to generate said web page so that said map image contains information that is pertinent to said provider;
said filter data including said geographic region and said time frame;
said filter data further including a provider asset location that is depicted in said map image to allow said provider to match said asset location with nearby missions; and
said web page being programmed to present specific information regarding a mission in response to selection of a vector corresponding to said mission using a computer cursor.

20. The method of claim 19 further including said information management system supports provider communication with users regarding mission delivery.
